(19) United States
(12) Patent Application Publication
(10) Pub. No.: US 2026/0289224 A1
(43) Pub. Date: Sep. 24, 2026

(54) ANTENNA DEVICE AND IC CARD HAVING THE SAME

(71) Applicant: TDK Corporation, Tokyo (JP)

(72) Inventors: Shoma KAJIKIYA, Tokyo (JP); Makoto HIRAKI, Tokyo (JP); Toshio TOMONARI, Tokyo (JP)

(73) Assignee: TDK Corporation, Tokyo (JP)

(21) Appl. No.: 19/568,857

(22) Filed: Mar. 17, 2026

(30) Foreign Application Priority Data
Mar. 19, 2025 (JP) 2025-044302

(51) Int. Cl. G06K 19/077; H01Q 1/22; H01Q 7/00

(52) U.S. Cl. CPC G06K 19/07773; H01Q 1/2216; H01Q 7/00

(57) ABSTRACT

Disclosed herein is an antenna device that includes a conductor pattern. The conductor pattern includes: a first loop portion extending in a first loop direction; a second loop portion extending in a second loop direction opposite to the first loop direction; a connection portion including a plurality of connection patterns connecting the first loop portion and the second loop portion; and end portions including one end and other end of the conductor pattern. The second loop portion and the end portions are disposed inside the first loop portion. The first loop portion is formed by a plurality of first conductive wires disposed in a mesh. The second loop portion and the end portions are formed by solid second conductive wires.

### CROSS-REFERENCE TO RELATED APPLICATION

This application claims the benefit of Japanese Patent Application No. 2025-044302, filed on Mar. 19, 2025, the entire disclosure of which is incorporated by reference herein.

### BACKGROUND

The present disclosure relates to an antenna device and an IC card having the same.

JP 2024-544048 discloses an IC card having an antenna device.

In the IC card disclosed in JP 2024-544048, a conductor pattern constituting the antenna device has a wide pattern width, so that when a card substrate having light transmissivity is used, the conductor pattern is undesirably visible. This may impair the external appearance when a transparent card substrate is used.

### SUMMARY

An antenna device according an aspect of the present disclosure includes a conductor pattern. The conductor pattern includes: a first loop portion extending in a first loop direction; a second loop portion extending in a second loop direction opposite to the first loop direction; a connection portion including a plurality of connection patterns connecting the first loop portion and the second loop portion; and end portions including one end and the other end of the conductor pattern. The second loop portion and the end portions are disposed inside the first loop portion. The first loop portion is formed by a plurality of first conductive wires disposed in a mesh. The second loop portion and the end portions are formed by solid second conductive wires.

An IC card according to an aspect of the present disclosure includes: a first card substrate having light transmissivity; a second card substrate having light transmissivity; the above-described antenna device disposed between the first card substrate and the second card substrate; and an IC module overlapping the second loop portion of the conductor pattern and the end portions of the conductor pattern.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the external appearance of an IC card 3 according to a first embodiment of the present disclosure, the IC card 3 including an antenna device 1;

FIG. 2 is a schematic exploded perspective view for explaining the structure of the IC card 3 including the antenna device 1;

FIG. 3 is a schematic cross-sectional view for explaining the structure of the IC card 3 including the antenna device 1;

FIG. 4 is a schematic plan view for explaining the structure of the conductor pattern 100;

FIG. 5 is a schematic enlarged plan view illustrating a portion of the conductor pattern 100;

FIG. 6 is a partial enlarged view of the mesh pattern 140;

FIGS. 7A to 7E are exploded views of the capacitor 60;

FIG. 8 is a schematic perspective view of the IC module 50 as viewed from the back surface side thereof;

FIG. 9 is a schematic diagram showing a state in which the IC card 3 and a card reader 7 communicate with each other;

FIG. 10 is a schematic plan view for explaining the configuration of a conductor pattern 100A according to a first modification;

FIG. 11 is a schematic plan view for explaining the configuration of a conductor pattern 100B according to a second modification;

FIG. 12 is a schematic enlarged plan view illustrating a portion of the conductor pattern 100B;

FIG. 13 is a schematic plan view illustrating an example in which ends of the conductive wires between adjacent turns overlap each other in the circumferential direction;

FIG. 14 is a schematic perspective view illustrating the external appearance of an IC card 4 according to a second embodiment of the present disclosure, the IC card 4 including an antenna device 2; and

FIGS. 15A to 15I are exploded views of the capacitor 70.

### DETAILED DESCRIPTION OF THE EMBODIMENTS

The present disclosure describes an antenna device capable of maintaining high-quality external appearance even when a card substrate having light transmissivity is used, and an IC card having such an antenna device.

Some embodiments of the present disclosure will be explained below in detail with reference to the accompanying drawings.

### First Embodiment

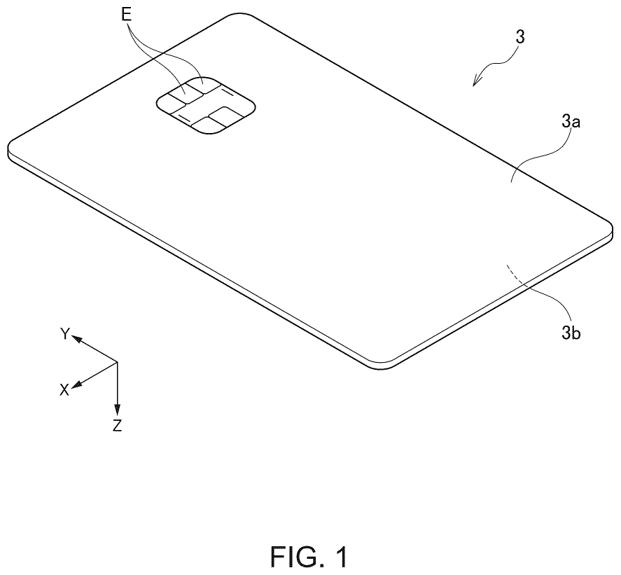

FIG. 1 is a schematic perspective view illustrating the external appearance of an IC card 3 according to a first embodiment of the present disclosure, the IC card 3 including an antenna device 1.

As illustrated in FIG. 1, the IC card 3 according to the present embodiment is formed into a plate shape, and its longer side direction, shorter side direction, and thickness direction are defined as the Y-direction, the X-direction, and the Z-direction, respectively. The IC card 3 has upper and back surfaces 3a and 3b constituting the XY plane. The IC card 3 incorporates therein an IC module to be described later, and a terminal electrode E of the IC module is exposed on the upper surface 3a of the IC card 3.

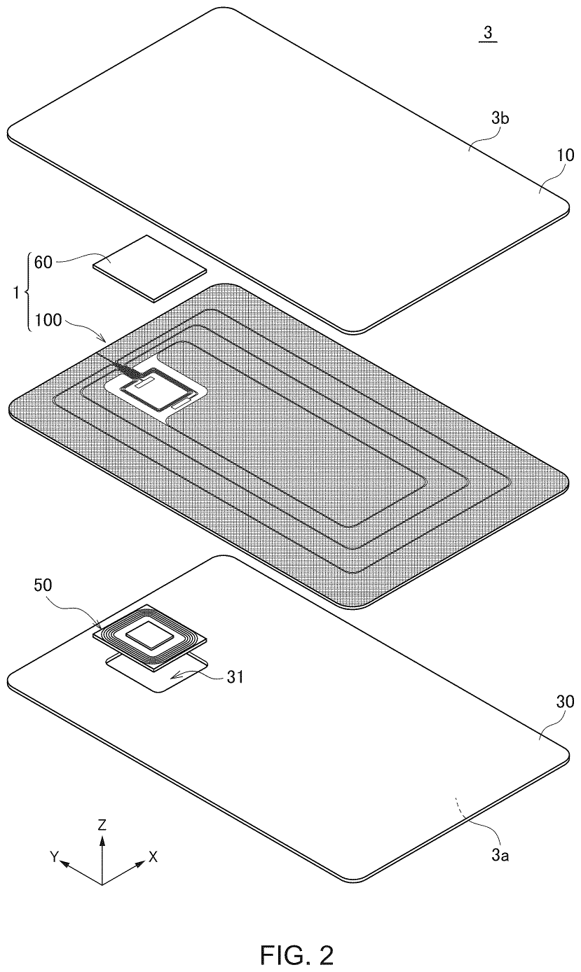

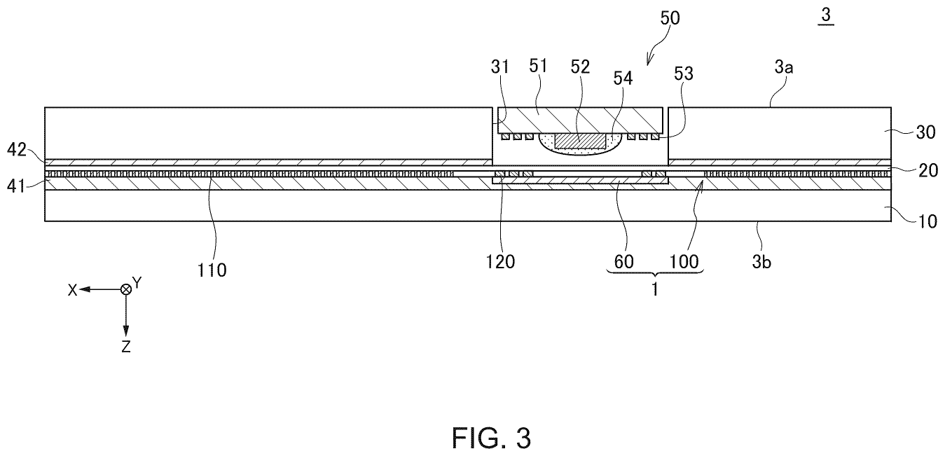

FIGS. 2 and 3 are a schematic exploded perspective view and a schematic cross-sectional view for explaining the structure of the IC card 3 according to the present embodiment, the IC card 3 including the antenna device 1.

The IC card 3 illustrated in FIGS. 2 and 3 has a structure in which a plastic plate 10, a capacitor 60, a support body 20, a conductor pattern 100 supported by the support body 20, and a plastic plate 30 are stacked in this order from the back surface 3b side toward the upper surface 3a side. The antenna device 1 according to the present embodiment includes the conductor pattern 100 and the capacitor 60. In the present embodiment, the conductor pattern 100 is disposed closer to the plastic plate 10 than the support body 20 is, and the support body 20 is disposed closer to the plastic plate 30 than the conductor pattern 100 is. The plastic plate 10, the support body 20, and the capacitor 60 are bonded together via an adhesive layer 41. The plastic plate 30 and the support body 20 are bonded together via an adhesive layer 42. Each of the adhesive layers 41 and 42 may be formed of an adhesive sheet made of a thermoplastic resin or a thermosetting resin having high transparency. The adhesive sheet constituting each of the adhesive layers 41 and 42 may be formed of an acrylic-based material, a urethane-based material, an epoxy-based material, or a phenol-based material. The support body 20 may be formed of a transparent resin film having light transmissivity. Examples of the transparent resin film constituting the support body 20 include polyethylene terephthalate (PET), polycarbonate (PC), polyethylene naphthalate (PEN), cycloolefin polymer (COP), and polymethyl methacrylate (PMMA). Alternatively, the support body 20 may be formed of a glass substrate. The total light transmissivity of each of the support body 20 and the adhesive layers 41 and 42 in a visible light region may be 80% or higher, and may preferably be 90% or higher.

The plastic plates 10 and 30 are each a card substrate formed of a resin material that does not block magnetic flux. The outer surface of the plastic plate 10 constitutes the back surface 3b of the IC card 3. The outer surface of the plastic plate 30 constitutes the upper surface 3a of the IC card 3. The plastic plates 10 and 30 are each formed of a material having light transmissivity. The plastic plates 10 and 30 may each be formed of a transparent resin material. Examples of the transparent resin material constituting each of the plastic plates 10 and 30 include cellulose propionate (CP), polyvinyl chloride (PVC), and polycarbonate (PC). The plastic plate 30 has a through hole 31 formed therein, and an IC module 50 is disposed in the through hole 31. Reinforced glass having light transmissivity may be used in place of each of the plastic plates 10 and 30. In general IC cards, the planar position of the terminal electrode E is specified by standards. Accordingly, a planar position of the through hole 31 formed in the plastic plate 30 needs to be determined in accordance with predetermined standards.

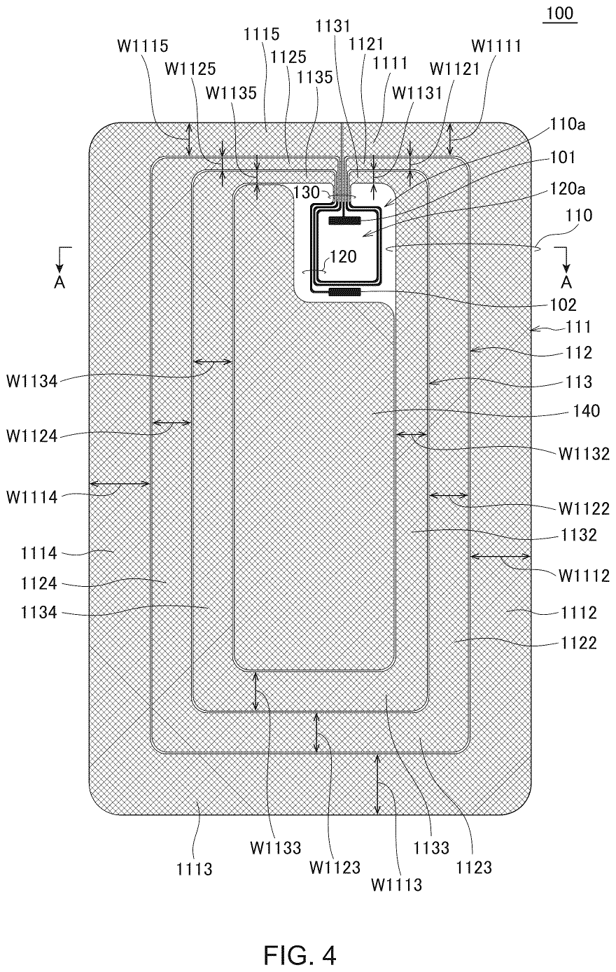

FIG. 4 is a schematic plan view for explaining the structure of the conductor pattern 100. The line A-A illustrated in FIG. 4 indicates the sectional position of FIG. 3.

As illustrated in FIG. 4, the conductor pattern 100 included in the antenna device 1 according to the present embodiment includes a first loop portion 110 extending over a plurality of turns, a second loop portion 120 extending over a plurality of turns, a connection portion 130 having a portion connecting the first and second loop portions 110 and 120, an end portion 101 constituting one end of the conductor pattern 100, and an end portion 102 constituting the other end of the conductor pattern 100. The conductor pattern 100 may be formed of copper, aluminum, silver, or the like. A resin may be interposed between the conductor pattern 100 and the support body 20. As viewed in FIG. 4, from the end portion 101 as a starting point to the end portion 102 as an end point, the first loop portion 110 extends right-handed (clockwise), while the second loop portion 120 extends left-handed (counterclockwise). That is, when the extending direction of the first loop portion 110 is defined as a first loop direction and the extending direction of the second loop portion 120 is defined as a second loop direction, the first and second loop directions are opposite to each other. The antenna device 1 according to the present embodiment further includes a mesh pattern 140. The mesh pattern 140 may be formed of the same material as the conductor pattern 100, or may be formed of a material different from that of the conductor pattern 100.

The second loop portion 120 and the end portions 101 and 102 are disposed in an inner diameter region 110a surrounded by the first loop portion 110. That is, the second loop portion 120 and the end portions 101 and 102 are located inside the first loop portion 110. The end portion 101 is disposed in an inner diameter region 120a surrounded by the second loop portion 120. That is, the end portion 101 is located inside the second loop portion 120. The end portion 102 is disposed in the inner diameter region 110a surrounded by the first loop portion 110 but outside the inner diameter region 120a surrounded by the second loop portion 120. That is, the end portion 102 is located inside the first loop portion 110 but outside the second loop portion 120.

As illustrated in FIG. 4, the second loop portion 120 and the end portions 101 and 102 are formed of solid conductive wires, whereas the first loop portion 110 is configured such that a plurality of conductive wires are disposed in a mesh.

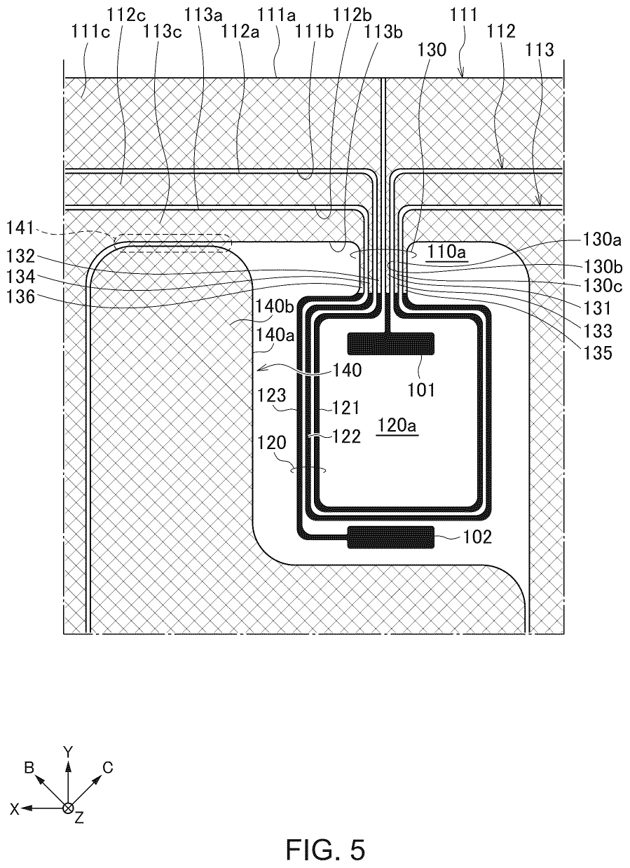

FIG. 5 is a schematic enlarged plan view illustrating a portion of the conductor pattern 100.

As illustrated in FIG. 5, the first loop portion 110 includes an outermost turn 111, an innermost turn 113, and a turn 112 located between the turns 111 and 113. One end of the turn 111 of the first loop portion 110 is connected to the end portion 101 of the conductor pattern 100 via a connection pattern 131 included in the connection portion 130.

The turn 111 includes a conductive wire 111a extending in the circumferential direction and constituting an outer peripheral edge, a conductive wire 111b extending in the circumferential direction and constituting an inner peripheral edge, and a plurality of conductive wires 111c located in a region sandwiched between the conductive wires 111a and 111b and obliquely extending in a mesh with respect to the conductive wires 111a and 111b. The turn 112 includes a conductive wire 112a extending in the circumferential direction and constituting an outer peripheral edge, a conductive wire 112b extending in the circumferential direction and constituting an inner peripheral edge, and a plurality of conductive wires 112c located in a region sandwiched between the conductive wires 112a and 112b and obliquely extending in a mesh with respect to the conductive wires 112a and 112b. The turn 113 includes a conductive wire 113a extending in the circumferential direction and constituting an outer peripheral edge, a conductive wire 113b extending in the circumferential direction and constituting an inner peripheral edge, and a plurality of conductive wires 113c located in a region sandwiched between the conductive wires 113a and 113b and obliquely extending in a mesh with respect to the conductive wires 113a and 113b.

In the example illustrated in FIG. 5, the conductive wires 111c, the conductive wires 112c, and the conductive wires 113c are each configured in a mesh, in which a plurality of portions extending in the B-direction inclined by 45° with respect to the X-and Y-directions and a plurality of portions extending in the C-direction orthogonal to the B-direction cross each other. It is not essential that the B-and C-directions be inclined with respect to the X- and Y-directions; however, inclining the B- and C-directions with respect to the X-and Y-directions makes disconnection unlikely to occur in the conductive wires 111c, 112c, and 113c configured in a mesh when the conductive wires 111c, 112c, and 113c are formed in the X-or Y-direction by a screen printing method. Alternatively, the conductive wires 111c, 112c, and 113c configured in a mesh may each have a structure in which a plurality of portions extending parallel to the X-direction and a plurality of portions extending parallel to the Y-direction cross each other.

The second loop portion 120 includes an innermost turn 121, an outermost turn 123, and a turn 122 located between the turns 121 and 123. One end of the turn 121 of the second loop portion 120 is connected to the other end of the turn 111 of the first loop portion 110 via a connection pattern 132 included in the connection portion 130. The other end of the turn 121 of the second loop portion 120 is connected to one end of the turn 112 of the first loop portion 110 via a connection pattern 133 included in the connection portion 130. One end of the turn 122 of the second loop portion 120 is connected to the other end of the turn 112 of the first loop portion 110 via a connection pattern 134 included in the connection portion 130. The other end of the turn 122 of the second loop portion 120 is connected to one end of the turn 113 of the first loop portion 110 via a connection pattern 135 included in the connection portion 130. One end of the turn 123 of the second loop portion 120 is connected to the other end of the turn 113 of the first loop portion 110 via a connection pattern 136 included in the connection portion 130. The other end of the turn 123 of the second loop portion 120 is connected to the end portion 102 of the conductor pattern 100. In the present embodiment, the end portion 102 of the conductor pattern 100 is located outside the second loop portion 120 in the Y-direction. Accordingly, the number of turns of the turn 123 of the second loop portion 120 is about one-half of a turn. The turn 123 of the second loop portion 120 varies in line length according to the position of the end portion 102 of the conductor pattern 100.

The connection patterns 131 to 136 included in the connection portion 130 each have the same mesh structure as the first loop portion 110. That is, the connection patterns 131 to 136 each include a conductive wire 130a constituting one edge, a conductive wire 130b constituting the other edge, and a plurality of conductive wires 130c located in a region sandwiched between the conductive wires 130a and 130b and obliquely extending in a mesh with respect to the conductive wires 130a and 130b. However, when the region sandwiched between the conductive wires 130a and 130b is narrow, the conductive wires 130c may have an imperfect mesh structure. Further, a mesh structure may be formed by the conductive wires 130a, 130b, and 130c.

On the other hand, the turns 121 to 123 constituting the second loop portion 120 each do not have a mesh structure, and are each formed of a solid conductor pattern. The same applies to the end portions 101 and 102. As illustrated in FIG. 5, the pattern widths of the end portions 101 and 102 may be larger than the width of each of the turns 121 to 123 of the second loop portion 120. The widths of the turns 121 to 123 of the second loop portion 120 are larger than the line widths of the conductive wires 111a to 111c, 112a to 112c, and 113a to 113c constituting the first loop portion 110 and the line widths of the conductive wires 130a to 130c constituting the connection portion 130. Accordingly, even though the second loop portion 120 has a diameter smaller than that of the first loop portion 110 and a turn width narrower than that of the first loop portion 110, a resistance of the second loop portion 120 can be reduced.

Since the first loop portion 110 is formed of a mesh thin-line pattern, the first loop portion 110 is difficult to visually recognize with the naked eye and appears substantially transparent. Accordingly, when the plastic plates 10 and 30 are each formed of a transparent resin material, the entire structure appears substantially transparent except for a portion in which the IC module 50 is disposed. This makes it possible to apply a design that cannot be applied to an IC card formed of an opaque material, thereby enhancing design flexibility. Although the second loop portion 120 is formed of a solid conductor pattern, the second loop portion 120 is disposed so as to overlap the IC module 50, thereby preventing design flexibility from being impaired.

As illustrated in FIG. 4, the turn 111 of the first loop portion 110 includes sections 1111, 1113, and 1115 extending in the X-direction and sections 1112 and 1114 extending in the Y-direction. One end of the section 1111 is connected to the end portion 101 of the conductor pattern 100 via the connection portion 130. One end of the section 1112 is connected to the other end of the section 1111. One end of the section 1113 is connected to the other end of the section 1112. One end of the section 1114 is connected to the other end of the section 1113. One end of the section 1115 is connected to the other end of the section 1114, and the other end thereof is connected to the second loop portion 120 via the connection portion 130. When the turn widths of the sections 1111 to 1115 are defined as W1111 to W1115, respectively, the relation W1112=W1113=W1114>W1111=W1115 holds in the example illustrated in FIG. 4. The pattern width of the turn 111 refers to a radial width of the turn 111, which is a dimension in a direction orthogonal to the thickness direction of the conductor pattern 100 and the circumferential direction of the turn 111. The turn width of the turn 111 need not be defined for each of the sections but may be defined by an average value of the turn widths of the sections 1111 to 1115 or by a maximum turn width of the sections 1111 to 1115. The same applies to the pattern widths of the turns 112 and 113.

The turn 112 of the first loop portion 110 includes sections 1121, 1123, and 1125 extending in the X-direction and sections 1122 and 1124 extending in the Y-direction. One end of the section 1121 is connected to the second loop portion 120 via the connection portion 130. One end of the section 1122 is connected to the other end of the section 1121. One end of the section 1123 is connected to the other end of the section 1122. One end of the section 1124 is connected to the other end of the section 1123. One end of the section 1125 is connected to the other end of the section 1124, and the other end thereof is connected to the second loop portion 120 via the connection portion 130. When the turn widths of the sections 1121 to 1125 are defined as W1121 to W1125, respectively, the relation W1122=W1123=W1124>W1121=W1125 holds in the example illustrated in FIG. 4.

The turn 113 of the first loop portion 110 includes sections 1131, 1133, and 1135 extending in the X-direction and sections 1132 and 1134 extending in the Y-direction. One end of the section 1131 is connected to the second loop portion 120 via the connection portion 130. One end of the section 1132 is connected to the other end of the section 1131. One end of the section 1133 is connected to the other end of the section 1132. One end of the section 1134 is connected to the other end of the section 1133. One end of the section 1135 is connected to the other end of the section 1134, and the other end thereof is connected to the second loop portion 120 via the connection portion 130. When the turn widths of the sections 1131 to 1135 are defined as W1131 to W1135, respectively, the relation W1132=W1133=W1134>W1131=W1135 holds in the example illustrated in FIG. 4.

The turn widths W1112 to W1114 of the sections 1112 to 1114 of the turn 111 may be larger than the turn widths W1122 to W1124 of the sections 1122 to 1124 of the turn 112 and the pattern widths W1132 to W1134 of the sections 1132 to 1134 of the turn 113. The turn widths W1111 and W1115 of the sections 1111 and 1115 of the turn 111 may be larger than the turn widths W1121 and W1125 of the sections 1121 and 1125 of the turn 112 and the pattern widths W1131 and W1135 of the sections 1131 and 1135 of the turn 113. This makes it possible to reduce a resistance value of the turn 111, which has a longer line length than the turns 112 and 113. That is, the outermost turn 111 of the first loop portion 110 has a larger turn width than the turns 112 and 113 located inside the turn 111, thereby reducing variations in resistance value caused by a peripheral position. Further, by making the turn width of the turn 111 larger than those of the turns 112 and 113, it is possible to extend the mesh structure up to the peripheral edge of the IC card 3 while maintaining characteristics required for the antenna device 1, thereby suppressing an influence on visibility.

Further, as illustrated in FIG. 5, the pattern widths of the connection patterns 131 to 136 constituting the connection portion 130 are narrower than the pattern widths of the turns 111 to 113 constituting the first loop portion 110. Accordingly, both end portions of the turns 111 to 113 in the X-direction become close to each other, thereby bringing revolution angles of the turns 111 to 113 closer to 360°, which enhances inductance.

Further, as illustrated in FIG. 4, the antenna device 1 according to the present embodiment includes the mesh pattern 140. The mesh pattern 140 is disposed in the inner diameter region 110a surrounded by the first loop portion 110 but outside the inner diameter region 120a surrounded by the second loop portion 120. As in the first loop portion 110, the mesh pattern 140 is formed of a mesh thin-line pattern. The mesh pattern 140 may have the same mesh width as the first loop portion 110. When the mesh pattern 140 configured as described above is provided, a difference between a light transmittance of a region in which the first loop portion 110 is present and a light transmittance of the inner diameter region 110a surrounded by the first loop portion 110 is reduced, whereby variations in light transmittance of the entire antenna device 1 are reduced, further enhancing design flexibility.

In the example illustrated in FIG. 5, the mesh pattern 140 includes a conductive wire 140a constituting an outer peripheral edge and conductive wires 140b disposed in a mesh in a region surrounded by the conductive wire 140a. The line widths of the conductive wires 140a and 140b constituting the mesh pattern 140 are the same as the line widths of the conductive wires 111a to 111c, 112a to 112c, and 113a to 113c constituting the first loop portion 110 and, accordingly, a light transmittance of a region in which the first loop portion 110 is present and a light transmittance of the inner diameter region 110a surrounded by the first loop portion 110 are substantially the same.

The mesh pattern 140 may be electrically insulated from or connected to the first loop portion 110. In the example illustrated in FIG. 5, the end portion of the mesh pattern 140 in the positive Y-direction is connected to the section 1135 of the innermost turn 113 of the first loop portion 110 via a mesh thin-line pattern 141. By thus using a conductive material for the mesh pattern 140 and electrically connecting the mesh pattern 140 and the first loop portion 110, electrical power can be fed to the mesh pattern 140 during a plating process.

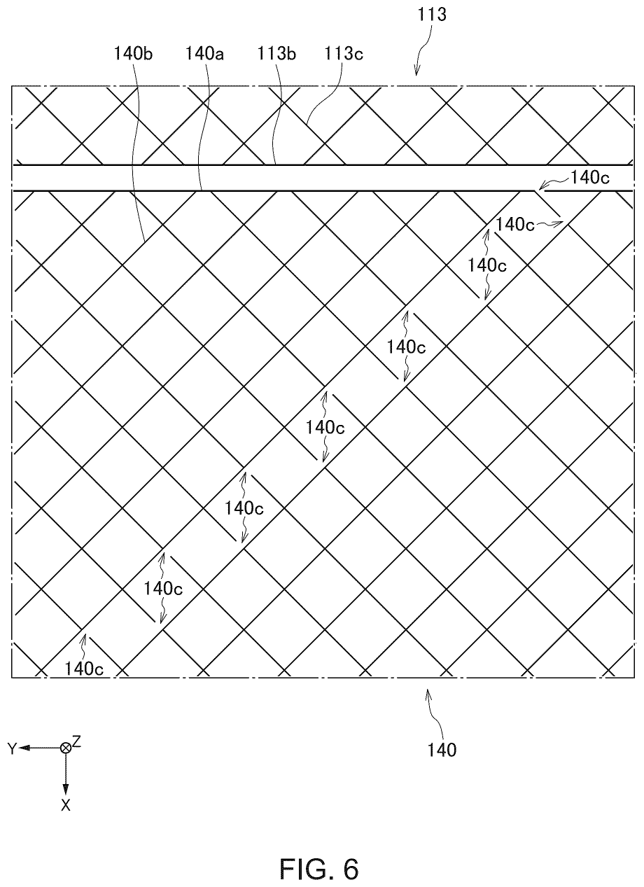

FIG. 6 is a partial enlarged view of the mesh pattern 140. As illustrated in FIG. 6, the mesh constituting the mesh pattern 140 may be partially divided by slits 140c extending inward from the peripheral edge. Some of the slits 140c divide the conductive wire 140a constituting the mesh pattern 140, and the remaining slits 140c divide the conductive wires 140b constituting the mesh pattern 140. When the mesh pattern 140 is partially divided by such slits 140c, eddy currents generated in the mesh pattern 140 is blocked by the slits 140c, whereby an eddy current induced loss can be reduced. In the example illustrated in FIG. 6, the slits 140c are formed in the vicinity of corner portions of lattices formed by the conductive wires 140b, whereby one slit 140c is shared by adjacent lattices. Further, two slits 140c assigned to one lattice are disposed in the vicinity of diagonal corner portions, so that the slits 140c are arranged in a zigzag manner, whereby the slits 140c become further difficult to visually recognize. This further suppresses an influence of the slits 140c on visibility.

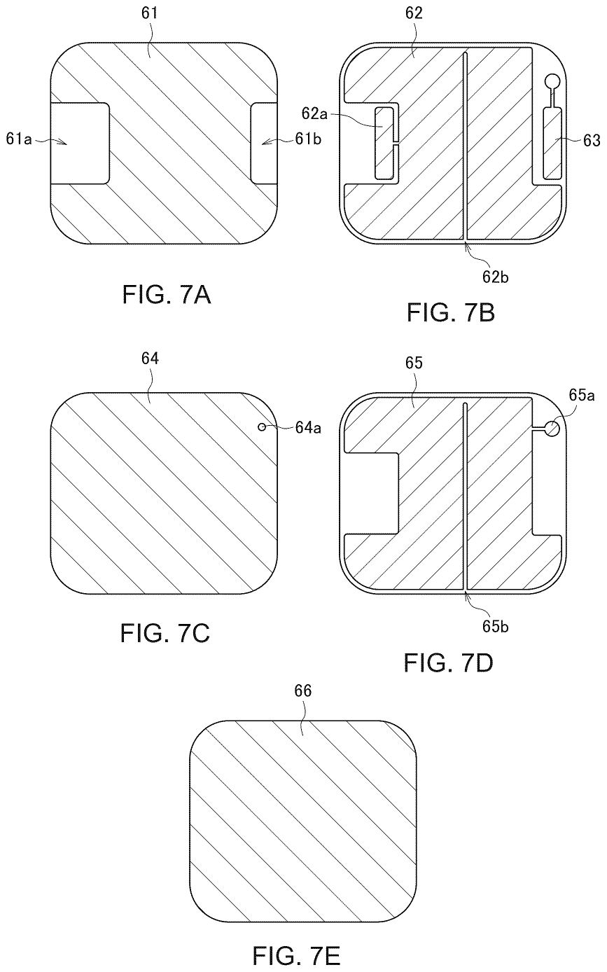

FIGS. 7A to 7E are exploded views of the capacitor 60.

In the example illustrated in FIG. 7A to 7E, a planar conductor 62 illustrated inn FIG. 7B is provided on one surface of a substrate 64 illustrated in FIG. 7C, and a planar conductor 65 illustrated in FIG. 7D is provided on the other surface of the substrate 64. The planar conductors 62 and 65 overlap each other with the substrate 64 interposed therebetween, thereby forming the capacitor 60 using the substrate 64 as a capacitive insulating film. The substrate 64 may be formed of polyimide (PI), polyethylene terephthalate (PET), or the like. A terminal conductor 62a connected to the planar conductor 62 is exposed through an opening 61a formed in a cover layer 61 illustrated in FIG. 7A. A connection portion 65a connected to the planar conductor 65 is connected to a terminal conductor 63 provided on the one surface of the substrate 64 via a through hole 64a illustrated in FIG. 7C. The terminal conductor 63 is exposed through an opening 61b formed in the cover layer 61 illustrated in FIG. 7A. The planar conductor 65 is covered with a cover layer 66. As described above, in the capacitor 60, a pair of terminal conductors 62a and 63 are both located on the one surface side of the substrate 64.

The capacitor 60 having the structure described above is disposed such that the terminal conductors 62a and 63 are respectively connected to the end portions 101 and 102 of the conductor pattern 100. Accordingly, the capacitor 60 is connected between the end portions 101 and 102 of the conductor pattern 100, thereby forming an LC resonance circuit.

As illustrated in FIG. 3, the capacitor 60 is disposed between the conductor pattern 100 and the plastic plate 10 so as to overlap the IC module 50. Thus, when the IC card 3 is viewed from the upper surface 3a side, the capacitor 60 located on the back surface side of the IC module 50 cannot be visually recognized. As described above, when the opaque IC module 50 and the capacitor 60 are disposed so as to overlap each other, a region having light transmissivity can be sufficiently ensured.

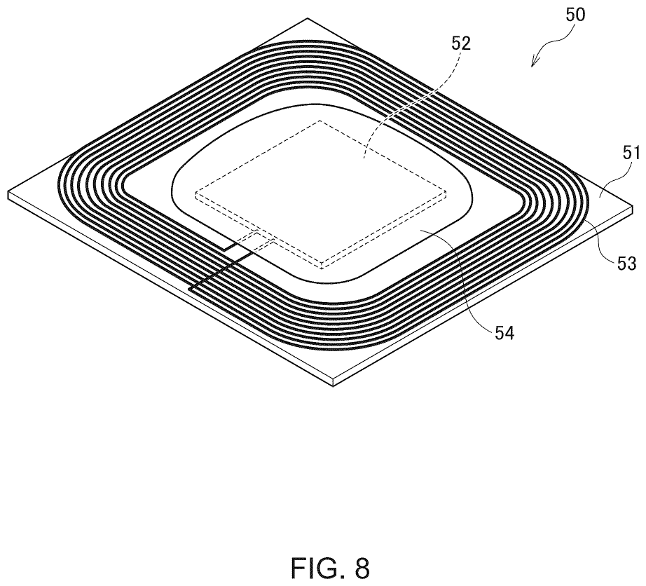

FIG. 8 is a schematic perspective view of the IC module 50 as viewed from the back surface side thereof.

As illustrated in FIG. 8, the IC module 50 includes a module substrate 51, an IC chip 52 mounted on or embedded in the module substrate 51, and a coupling coil 53. The IC chip 52 is protected by being covered with a dome-shaped protective resin 54. The protective resin 54 is formed of an insulating member. The terminal electrode E illustrated in FIG. 1 is provided on the front surface side of the module substrate 51. The IC module 50 thus configured is accommodated in the through hole 31 formed in the plastic plate 30. In a state in which the IC module 50 is accommodated in the through hole 31, the coupling coil 53 and the second loop portion 120 of the conductor pattern 100 are electromagnetically coupled to each other. Since the second loop portion 120 is connected to the first loop portion 110, which functions an antenna coil, the IC module 50 can communicate with an external device via the first loop portion 110.

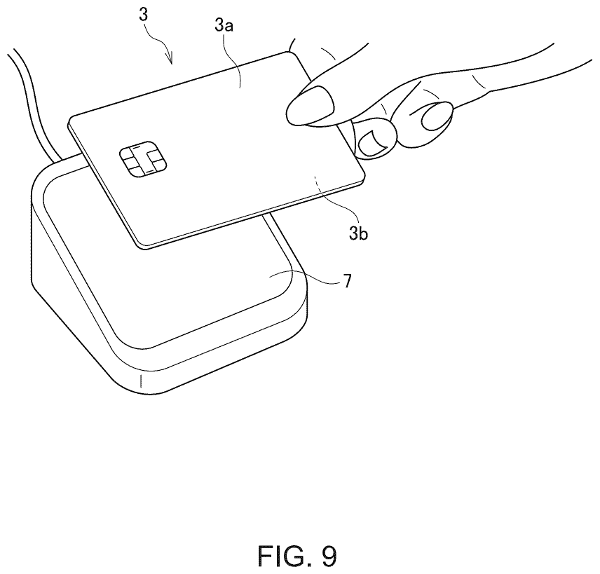

Thus, as illustrated in FIG. 9, when the upper surface 3a or the back surface 3b of the IC card 3 is made to face a card reader 7, communication can be performed between the card reader 7 and the IC chip 52. That is, the card reader 7 is coupled to the coupling coil 53 of the IC module 50 via the conductor pattern 100, and can thereby communicate with the IC chip 52.

The planar conductor 62 illustrated in FIG. 7B has a slit 62b extending inward from the peripheral edge, and the planar conductor 65 illustrated in FIG. 7D has a slit 65b extending inward from the peripheral edge. The slits 62b and 65b may overlap each other in the stacking direction. In a plan view as seen from the Z-direction, the slits 62b and 65b are disposed so as to overlap the inner diameter region 120a of the second loop portion 120 of the conductor pattern 100 and the inner diameter region of the coupling coil 53 of the IC module 50. Forming the slits 62b and 65b configured as described above in the planar conductors 62 and 65 allows magnetic flux required for electromagnetic coupling between the second loop portion 120 of the conductor pattern 100 and the coupling coil 53 of the IC module 50 to pass therethrough, thereby making it possible to reduce eddy currents generated in the planar conductors 62 and 65.

As described above, in the antenna device 1 according to the present embodiment, the first loop portion 110, which functions as an antenna coil, is formed of a mesh thin-line pattern, so that when the plastic plates 10 and 30 having light transmissivity are used, substantially the entire IC card 3 can be made transparent or translucent except for a portion where the IC module 50 is disposed.

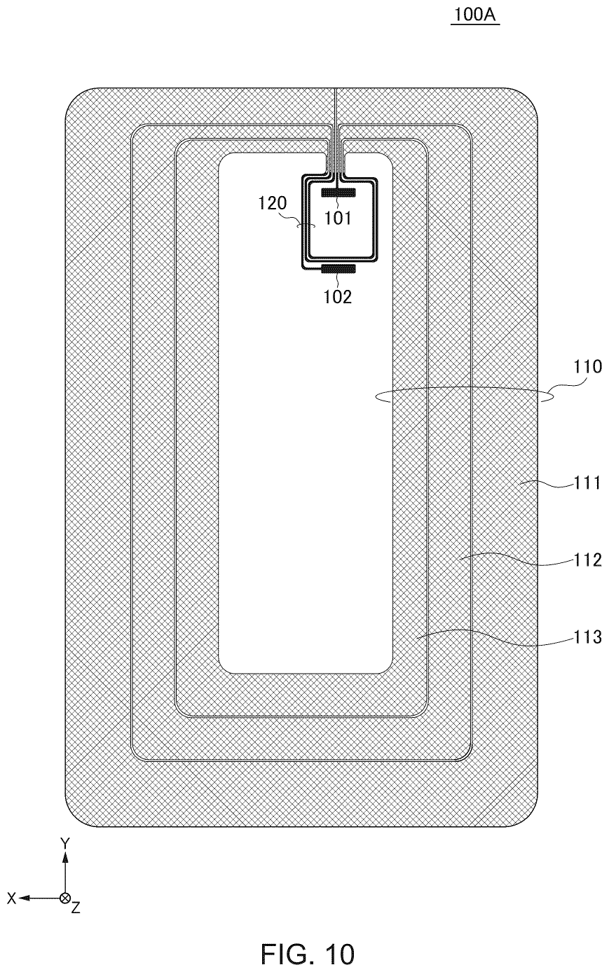

FIG. 10 is a schematic plan view for explaining the configuration of a conductor pattern 100A according to a first modification.

The conductor pattern 100A according to the first modification illustrated in FIG. 10 differs from the above-described conductor pattern 100 in that the mesh pattern 140 has been removed. As exemplified by the conductor pattern 100A according to the first modification, it is not essential that the mesh pattern 140 be provided in the conductor pattern 100.

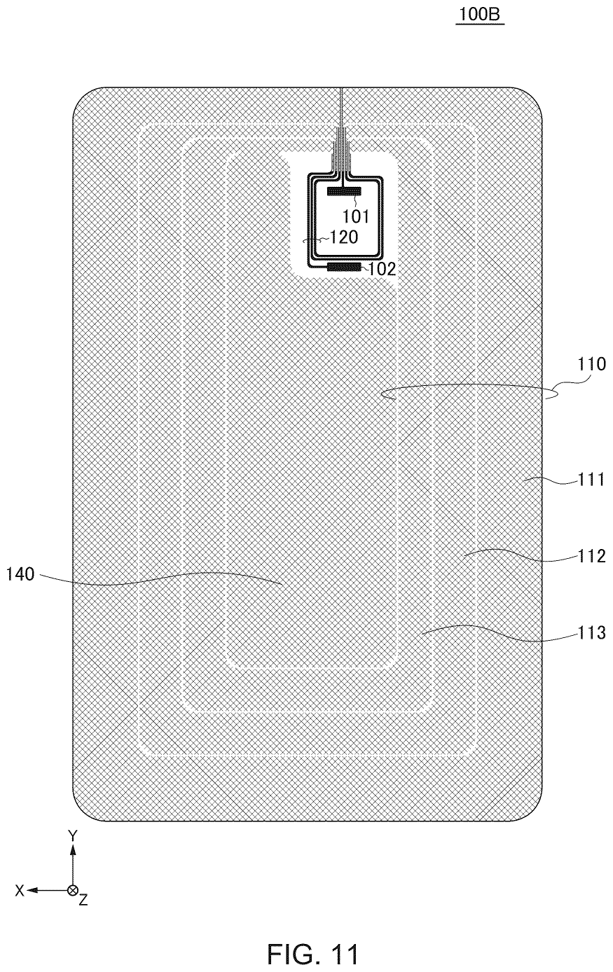

FIG. 11 is a schematic plan view for explaining the configuration of a conductor pattern 100B according to a second modification.

The conductor pattern 100B according to the second modification illustrated in FIG. 11 differs from the above-described conductor pattern 100 in that the conductive wires 111a, 111b, 112a, 112b, 113a, 113b, and 140a constituting the edges of the first loop portion 110 and the mesh pattern 140 have been removed. As exemplified by the conductor pattern 100B according to the second modification, the conductive wires constituting the edges of the first loop portion 110 and the mesh pattern 140 may be removed. In this case, the first loop portion 110 may be formed only by the conductive wires 111c, 112c, and 113c configured in a mesh, and the mesh pattern 140 may be formed only by the mesh conductive wires 140b. This makes it more difficult to visually recognize a portion between adjacent turns of the first loop portion 110 and a boundary between the first loop portion 110 and the mesh pattern 140, thereby further enhancing design flexibility.

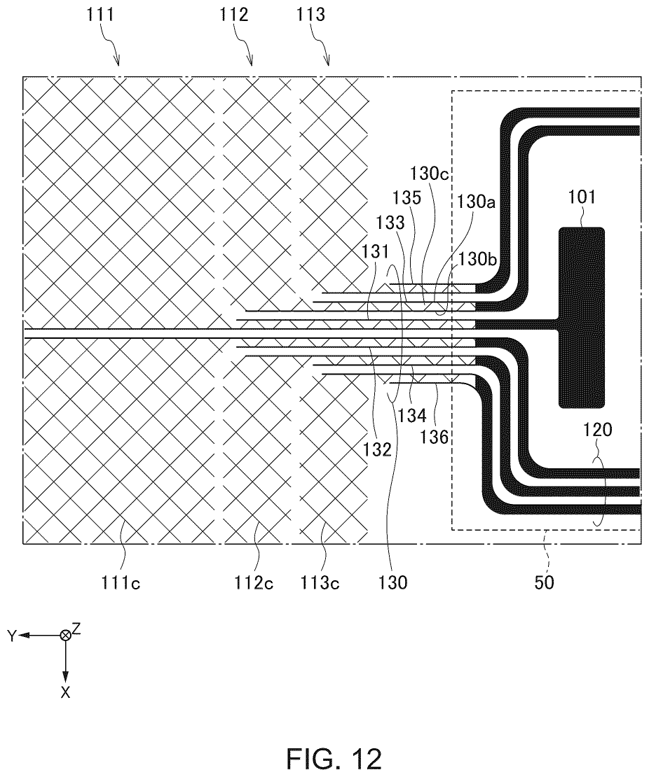

Even in this case, as illustrated in FIG. 12, the connection patterns 131 to 136 constituting the connection portion 130 use the conductive wires 130a and 130b constituting the edges, and can thereby prevent disconnection in the connection portion 130. The connection patterns 131 to 136 constituting the connection portion 130 may be configured such that the entire region each thereof in the Y-direction is formed by a mesh thin-line pattern, or such that a portion of a region each thereof that is located on the second loop portion 120 is formed by a solid conductor pattern. Even when a portion of a region of the connection patterns 131 to 136 is formed by a solid conductor pattern, it is possible to make a region formed by a solid conductor pattern invisible by the IC module 50 by limiting the region to an area overlapping the IC module 50. However, in consideration of alignment errors occurring in an assembly process in which the IC module 50 is disposed so as to overlap the conductor pattern 100, among the connection patterns 131 to 136, at least a portion of a region formed by the conductive wires 130a to 130c configured in a mesh may be designed to overlap the IC module 50, as indicated by reference numeral 50 in FIG. 12.

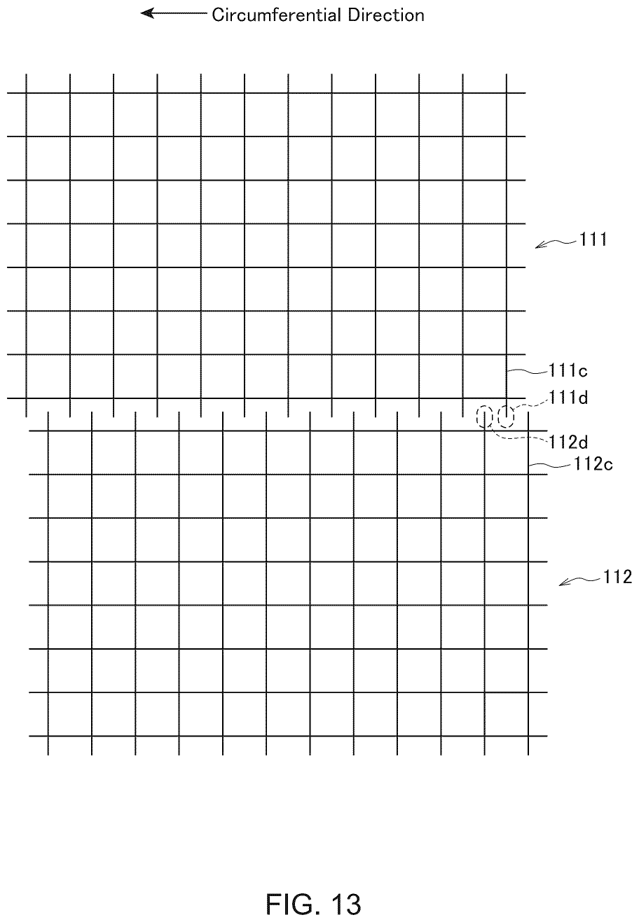

Further, as illustrated in FIG. 13, the mesh conductive wires may be arranged so as to have overlaps in the circumferential direction between adjacent turns of the first loop portion 110. In the example illustrated in FIG. 13, an end portion 111d of the conductive wire 111c constituting the turn 111 and an end portion 112d of the conductive wire 112c constituting the turn 112 are arranged in a nested array so as to overlap each other in the circumferential direction. This makes it more difficult to visually recognize a portion between adjacent turns of the first loop portion 110, thereby further enhancing flexibility. Such a nested arrangement may be applied also to a boundary between the first loop portion 110 and the mesh pattern 140 so as to make the mesh conductive wires belonging to the first loop portion 110 and the mesh pattern 140 overlap each other in the circumferential direction. The conductor pattern illustrated in FIG. 13 may be a pattern inclined with respect to the circumferential direction, a pattern extending in parallel to the circumferential direction, or a pattern extending in a direction perpendicular to the circumferential direction.

### Second Embodiment

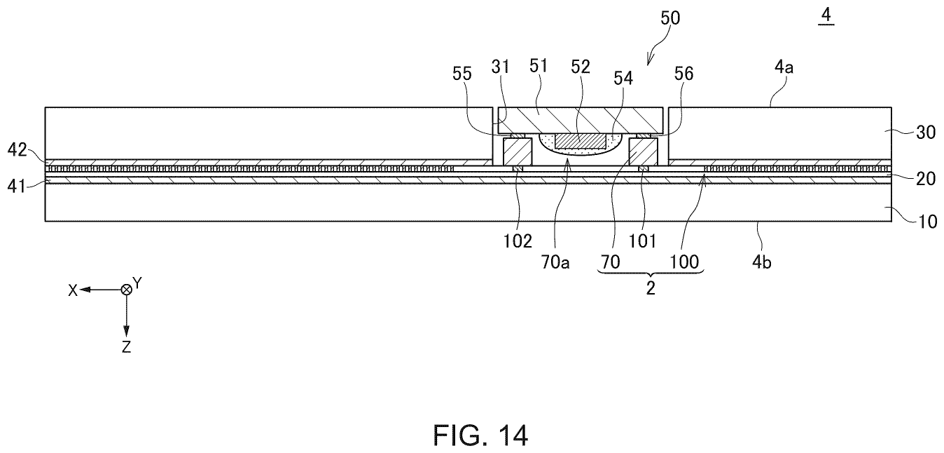

FIG. 14 is a schematic perspective view illustrating the external appearance of an IC card 4 according to a second embodiment of the present disclosure, the IC card 4 including an antenna device 2.

As illustrated in FIG. 14, the IC card 4 according to the second embodiment differs from the IC card 3 according to the first embodiment in that the capacitor 60 is replaced with a capacitor 70 and that the coupling coil 53 provided in the IC module 50 is replaced with a pair of connection terminals 55 and 56. Further, in the present embodiment, the conductor pattern 100 is disposed closer to the plastic plate 30 than the support body 20 is, and the support body 20 is disposed closer to the plastic plate 10 than the conductor pattern 100 is. Further, the capacitor 70 is disposed between the conductor pattern 100 and the IC module 50. Other basic configurations are the same as those of the IC card 3 according to the first embodiment, so the same reference numerals are given to the same elements, and overlapping description will be omitted. The antenna device 2 according to the present embodiment includes the conductor pattern 100 and the capacitor 70. The capacitor 70 has a tubular body having a hollow portion 70a, and the IC chip 52 or the protective resin 54 is partially located in the hollow portion 70a. The outer surface of the plastic plate 10 constitutes a back surface 4b of the IC card 4. The outer surface of the plastic plate 30 constitutes an upper surface 4a of the IC card 4.

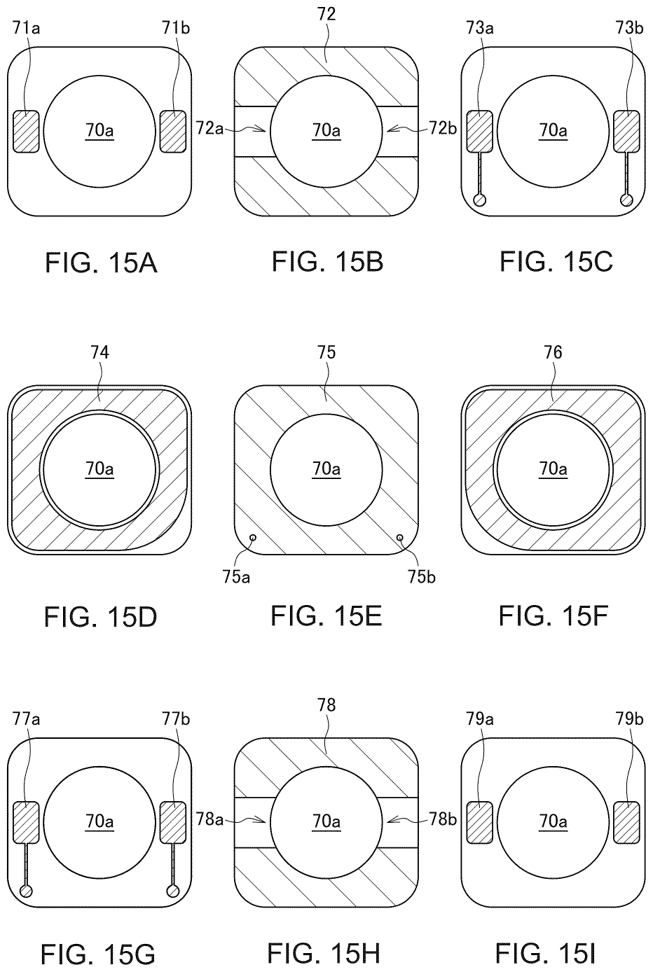

FIGS. 15A to 15I are exploded views of the capacitor 70.

In the example illustrated in FIGS. 15A to 15I, a planar conductor 74 illustrated in FIG. 15D is provided on one surface of an insulating layer 75 illustrated in FIG. 15E, and a planar conductor 76 illustrated in FIG. 15F is provided on the other surface of the insulating layer 75 illustrated in FIG. 15E. Planar conductors 74 and 76 overlap each other with the insulating layer 75 interposed therebetween, thereby forming the capacitor 70 using the insulating layer75 as a capacitive insulating film. The planar conductor 74 is connected to a terminal conductor 73a illustrated in FIG. 15C via a through hole (not illustrated) formed in an insulating layer covering one surface of the insulating layer 75. The planar conductor 74 is also connected to a terminal conductor 77a illustrated in FIG. 15G via a through hole 75a formed in the insulating layer 75 and a through hole (not illustrated) formed in an insulating layer covering the other surface of the insulating layer 75. The planar conductor 76 is connected to a terminal conductor 77b illustrated in FIG. 15G via a through hole (not illustrated) formed in the insulating layer covering the other surface of the insulating layer 75. The planar conductor 76 is also connected to a terminal conductor 73b illustrated in FIG. 15C via a through hole 75b formed in the insulating layer 75 and a through hole (not illustrated) formed in the insulating layer covering the one surface of the insulating layer 75. The insulating layer 75 and the insulating layers formed on both surfaces thereof together constitute a multilayer substrate, on one surface of which the terminal conductors 73a and 73b are provided, and on the other surface of which the terminal conductors 77a and 77b are provided. The planar conductors 74 and 76 are located in the multilayer substrate and are disposed opposite to each other with the insulating layer 75 interposed therebetween in the thickness direction of the substrate. The terminal conductors 73a, 73b, 77a, and 77b, and the planar conductors 74 and 76 are formed of, for example, copper.

The terminal conductors 73a and 73b are exposed through openings 72a and 72b formed in a cover layer 72 illustrated in FIG. 15B, and surfaces thereof are respectively covered with plated terminal conductors 71a and 71b illustrated in FIG. 15A. The terminal conductors 77a and 77b are exposed through openings 78a and 78b formed in a cover layer 78 illustrated in FIG. 15H, and surfaces thereof are respectively covered with plated terminal conductors 79a and 79b illustrated in FIG. 15I. As described above, the capacitor 70 includes a multilayer substrate, on one surface of which a pair of terminal conductors 73a and 73b and a pair of plated terminal conductors 71a and 71b are provided, and on the other surface of which a pair of terminal conductors 77a and 77b and a pair of plated terminal conductors 79a and 79b are provided.

In the capacitor 70 having such a structure, the terminal conductor 73a and the plated terminal conductor 71a are connected to the end portion 101 of the conductor pattern 100, the terminal conductor 73b and the plated terminal conductor 71b are connected to the end portion 102 of the conductor pattern 100, the terminal conductor 77a and the plated terminal conductor 79a are connected to the connection terminal 55 of the IC module 50, and the terminal conductor 77b and the plated terminal conductor 79b are connected to the connection terminal 56 of the IC module 50. As a result, the end portion 101 of the conductor pattern 100 and the connection terminal 55 of the IC module 50 are directly connected to each other, the end portion 102 of the conductor pattern 100 and the connection terminal 56 of the IC module 50 are directly connected to each other, and the capacitor 70 is connected between the end portion 101 (connection terminal 55 of the IC module 50) of the conductor pattern 100 and the end portion 102 (connection terminal 56 of the IC module 50) of the conductor pattern 100. The capacitor 70 also functions to fix the IC module 50 in the through hole 31.

As described above, in the second embodiment, the conductor pattern 100 and the IC module 50 are not electromagnetically coupled, but they are directly connected via the conductors included in the capacitor 70. As exemplified in the second embodiment, the conductor pattern 100 and the IC module 50 may be directly connected to each other. In this case, although the second loop portion 120 is not required in principle, using the same conductor pattern 100 as that used in the first embodiment makes it possible to ensure compatibility. That is, when the conductor pattern 100 illustrated in FIG. 4 is used, it is possible to achieve the first embodiment by a combination of the conductor pattern 100 and the capacitor 60 and to achieve the second embodiment by a combination of the conductor pattern 100 and the capacitor 70.

While some embodiments of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An antenna device according an aspect of the present disclosure includes a conductor pattern. The conductor pattern includes: a first loop portion extending in a first loop direction; a second loop portion extending in a second loop direction opposite to the first loop direction; a connection portion including a plurality of connection patterns connecting the first loop portion and the second loop portion; and end portions including one end and the other end of the conductor pattern. The second loop portion and the end portions are disposed inside the first loop portion. The first loop portion is formed by a plurality of first conductive wires disposed in a mesh. The second loop portion and the end portions are formed by solid second conductive wires. This makes the first loop portion difficult to visually recognize, and causes the antenna device to appear substantially transparent except for the second loop portion.

In the above antenna device, the second loop portion may have a turn width larger than a line width of the first conductive wires. This makes it possible to reduce a resistance of the second loop portion.

In the antenna device, the second loop portion may have a narrower turn width than the first loop portion. This makes it possible to enhance inductance while maintaining the size of the second loop portion.

In the above antenna device, the outermost turn of the first loop portion may have a larger turn width than the other turns of the first loop portion located inside the outermost turn. This makes it possible to reduce variations in a resistance value caused by a peripheral position.

In the above antenna device, a width of each of the plurality of connection patterns may be narrower than a turn width of the first loop portion. This makes it possible to enhance inductance of the first loop portion.

The above antenna device may further include a mesh pattern disposed inside the first loop portion. This makes it possible to reduce a difference between light transmissivity of the first loop portion and light transmissivity of a portion inside the first loop portion.

In the above antenna device, the mesh pattern may be formed by third conductive wires disposed in a mesh. This makes it possible to make the light transmissivity of the entire antenna device substantially uniform.

In the above antenna device, a mesh constituting the mesh pattern may be partially divided by a slit extending inward from the peripheral edge. This makes it possible to reduce eddy currents generated in the mesh pattern.

The above antenna device may further include a capacitor connected to the end portions of the conductor pattern. This can constitute an LC resonance circuit.

In the above antenna device, the capacitor may include: a substrate; a first planar conductor formed on one surface of the substrate; a second planar conductor formed on the other surface of the substrate; a first terminal conductor connected to the first planar conductor; and a second terminal conductor connected to the second planar conductor. The first terminal conductor and the second terminal conductor may be both located on the one surface side of the substrate. The first terminal conductor may be connected to the one end of the conductor pattern, and the second terminal conductor may be connected to the other end of the conductor pattern. This allows the capacitor to be disposed so as to overlap the conductor pattern.

In the above antenna device, the capacitor may include: a substrate; first and second terminal conductors formed on one surface of the substrate; third and fourth terminal conductors formed on the other surface of the substrate; and first and second planar conductors provided in the substrate and disposed opposite to each other so as to be spaced from each other in the thickness direction of the substrate. The first planar conductor may be connected to the first terminal conductor and the third terminal conductor, and the second planar conductor may be connected to the second terminal conductor and the fourth terminal conductor. The first terminal conductor may be connected to the one end of the conductor pattern, and the second terminal conductor may be connected to the other end of the conductor pattern. This allows direct connection between an IC module disposed on the other surface side of the substrate and the capacitor.

In the above antenna device, the first planar conductor and the second planar conductor may have a slit extending inward from the peripheral edge. This makes it possible to reduce eddy currents generated in the first and second planar conductors.

In the above antenna device, the slit formed in the first planar conductor and the slit formed in the second planar conductor may at least partially overlap each other in the stacking direction. This makes it possible to reduce eddy currents.

In the above antenna device, a radial end portion of each of the mesh, first conductive wires constituting a first turn belonging to the first loop portion and a radial end portion of each of the mesh first conductive wires constituting a second turn belonging to the first loop portion and adjacent to the first turn may at least partially overlap each other in the circumferential direction. This makes a boundary between the first and second turns more difficult to visually recognize.

An IC card according to an aspect of the present disclosure includes: a first card substrate having light transmissivity; a second card substrate having light transmissivity; the above-described antenna device disposed between the first card substrate and the second card substrate; and an IC module overlapping the second loop portion of the conductor pattern and the end portions of the conductor pattern. With this configuration, the IC card is configured to be light-transmissive as a whole except for a portion in which the IC module is disposed.

In the above IC card, at least a portion of the connection portion of the conductor pattern may be formed by the plurality of first conductive wires disposed in a mesh, and in the connection portion, at least a portion of a region where the plurality of first conductive wires are disposed in a mesh may overlap the IC module. With this configuration, transparency of the connection portion can be maintained even when alignment errors occur during an assembly process.

An IC card according to another aspect of the present disclosure includes: a first card substrate having light transmissivity; a second card substrate having light transmissivity; the above-described antenna device disposed between the first card substrate and the second card substrate; and an IC module overlapping the second loop portion of the conductor pattern and the end portions of the conductor pattern, and the third terminal conductor and the fourth terminal conductor are connected to the IC module. This allows direct connection between the conductor pattern and the IC module.

What is claimed is:

1. An antenna device comprising a conductor pattern,
wherein the conductor pattern includes:
a first loop portion extending in a first loop direction;
a second loop portion extending in a second loop direction opposite to the first loop direction;
a connection portion including a plurality of connection patterns connecting the first loop portion and the second loop portion; and
end portions including one end and other end of the conductor pattern,
wherein the second loop portion and the end portions are disposed inside the first loop portion,
wherein the first loop portion is formed by a plurality of first conductive wires disposed in a mesh, and
wherein the second loop portion and the end portions are formed by solid second conductive wires.

2. The antenna device as claimed in claim 1, wherein the second loop portion has a turn width larger than a line width of the first conductive wires.

3. The antenna device as claimed in claim 1, wherein the second loop portion has a narrower turn width than the first loop portion.

4. The antenna device as claimed in claim 1, wherein an outermost turn of the first loop portion has a larger turn width than other turns of the first loop portion located inside the outermost turn.

5. The antenna device as claimed in claim 1, wherein a width of each of the plurality of connection patterns is narrower than a turn width of the first loop portion.

6. The antenna device as claimed in claim 1, further comprising a mesh pattern disposed inside the first loop portion.

7. The antenna device as claimed in claim 6, wherein the mesh pattern is formed by third conductive wires disposed in a mesh.

8. The antenna device as claimed in claim 6, wherein a mesh constituting the mesh pattern is partially divided by a slit extending inward from a peripheral edge.

9. The antenna device as claimed in claim 1, further comprising a capacitor connected to the end portions of the conductor pattern.

10. The antenna device as claimed in claim 9,
wherein the capacitor includes:
a substrate;
a first planar conductor formed on one surface of the substrate;
a second planar conductor formed on other surface of the substrate;
a first terminal conductor connected to the first planar conductor; and
a second terminal conductor connected to the second planar conductor,
wherein the first terminal conductor and the second terminal conductor are both located on the one surface side of the substrate,
wherein the first terminal conductor is connected to the one end of the conductor pattern, and
wherein the second terminal conductor is connected to the other end of the conductor pattern.

11. The antenna device as claimed in claim 9,
wherein the capacitor includes:
a substrate;
first and second terminal conductors formed on one surface of the substrate;
third and fourth terminal conductors formed on other surface of the substrate; and
first and second planar conductors provided in the substrate and disposed opposite to each other so as to be spaced from each other in a thickness direction of the substrate,
wherein the first planar conductor is connected to the first terminal conductor and the third terminal conductor,
wherein the second planar conductor is connected to the second terminal conductor and the fourth terminal conductor,
wherein the first terminal conductor is connected to the one end of the conductor pattern, and
wherein the second terminal conductor is connected to the other end of the conductor pattern.

12. The antenna device as claimed in claim 10, wherein the first planar conductor and the second planar conductor have a slit extending inward from a peripheral edge.

13. The antenna device as claimed in claim 12, wherein the slit formed in the first planar conductor and the slit formed in the second planar conductor at least partially overlap each other in a stacking direction.

14. The antenna device as claimed in claim 1, wherein a radial end portion of each of the mesh first conductive wires constituting a first turn belonging to the first loop portion and a radial end portion of each of the mesh first conductive wires constituting a second turn belonging to the first loop portion and adjacent to the first turn at least partially overlap each other in a circumferential direction.

15. An IC card comprising:
a first card substrate having light transmissivity;
a second card substrate having light transmissivity;
the antenna device as claimed in claim 1 disposed between the first card substrate and the second card substrate; and
an IC module overlapping the second loop portion of the conductor pattern and the end portions of the conductor pattern.

16. The IC card as claimed in claim 15,
wherein at least a portion of the connection portion of the conductor pattern is formed by the plurality of first conductive wires disposed in a mesh, and
wherein, in the connection portion, at least a portion of a region where the plurality of first conductive wires are disposed in a mesh overlaps the IC module.

17. An IC card comprising:
a first card substrate having light transmissivity;
a second card substrate having light transmissivity;
the antenna device as claimed in claim 11 disposed between the first card substrate and the second card substrate; and
an IC module overlapping the second loop portion of the conductor pattern and the end portions of the conductor pattern,
wherein the third terminal conductor and the fourth terminal conductor are connected to the IC module.
